(19) United States
(12) Patent Application Publication
(10) Pub. No.: US 2019/0133357 A1
(43) Pub. Date: May 9, 2019

(54) Devices and Methods for Feeding or Medicating Infants

(71) Applicant: Debra Stone, Fairfield, CT (US)

(72) Inventor: Debra Stone, Fairfield, CT (US)

(21) Appl. No.: 16/183,987

(22) Filed: Nov. 8, 2018

Related U.S. Application Data
(60) Provisional application No. 62/707,574, filed on Nov. 9, 2017.

(51) Int. Cl. A47G 21/04; A61J 7/00

(52) U.S. Cl. CPC A47G 21/04; A61J 7/0023

(57) ABSTRACT

A feeding accessory or tool for administering food or medication to neonatal infants, utilizes a storage part and a spoon part. The latter has upstanding side flanges to direct food or medications along a channel between the flanges. The spoon part has an end flange with a central depression that can complement an infant's tongue and lips, to simplify administration of the food or medications, as the case may be. Improved transfer from the storage part to the infant's mouth is thereby achievable. The device can be inexpensively fabricated using simple mold cavities for plastic articles such as the present tool.

### CROSS REFERENCES TO RELATED APPLICATIONS

This application claims priority from U.S. Provisional Application No. 62/707,574 filed Nov. 9, 2017, the contents of which are incorporated by reference.

### FIELD

The embodiments disclosed herein relate to care of neonatal infants, and more particularly to instruments for feeding or medicating the infant.

### BACKGROUND

Existing feed devices consisted of a storage tube and connected spoon, where the spoon was characterized by an upstanding, continuous outer edge or flange. This construction had a disadvantage involving interference between the edge and the infant's lip and/or tongue. Thus, smooth flow of the food or medication being dispensed was often difficult to accomplish.

Stated differently, in prior feeding designs there was no direct path for the infant's tongue to reach out beyond his gum line to ‘lap’ up food or medication from the device.

### SUMMARY

The embodiments described herein particularly address the above problem and thus obviate sane inherent drawbacks and disadvantages.

One of the objects of the embodiments disclosed herein is to provide a novel and improved, inexpensive feeding device which is simple in its structure and especially easy to use.

The disclosed embodiments provide a feeding accessory for administering food or medication to neonatal infants, comprising in combination an elongate tubular storage part having an open end and a closed end, for temporarily holding measured quantities of food or medication to be administered orally to an infant, as by a parent at home, or a nurse, or other care provider, a spoon part having a proximal end that is connected to the storage part at its open end, and having a distal end adapted to engage the infant's lips and tongue, said spoon part having two oppositely disposed upwardly extending side flanges, to channel the flow of the food or medication toward the distal end of the spoon part, said spoon part further having at its distal end, a transverse upwardly extending flange transverse to its side flanges, said distal end of the spoon part further comprising a central depression, constituting a cradling seat for the infant's tongue while the food or medication is exiting the spoon part and entering the mouth of the infant.

Another embodiment is a method of feeding an infant, comprising: obtaining a portable feeding accessory comprising an elongate tubular storage part having an open end and a closed end, for temporarily holding a liquid to be administered orally to an infant, and a spoon part connected to the storage part and having a distal portion comprising a central depression configured to receive an infant's tongue during a feeding, depositing the liquid into the storage part, pivoting the feeding accessory in order that a portion of the liquid moves from the storage part to the spoon part, and placing the distal portion of the spoon part in contact with the lips of an infant, thereby enabling the infant to move their tongue onto the spoon part through the central depression in order to drink at least a portion of the liquid located in the spoon portion using their tongue. In some cases, the method further comprises, after enabling the infant to drink at least a portion of the liquid located in the spoon using their tongue, further pivoting the spoon part to cause additional liquid to move from the storage part to the spoon part of the feeding accessory.

Another embodiment is a method of teaching an infant a tongue movement comprising feeding a liquid to the infant using the feeding accessory described above. In embodiments, the tongue movement is an action that trains an infant for future breastfeeding.

Other features and advantages will hereinafter appear.

### BRIEF DESCRIPTION OF THE DRAWINGS

In the accompanying drawings:

FIG. 1 is perspective top view of the improved feeding accessory of the present invention.

FIG. 2 is a side elevation of the accessory of FIG. 1.

FIG. 3 is a top plan view of the accessory of FIGS. 1 and 2.

FIG. 4 is a right end elevation of the accessory of FIGS. 1-3.

FIG. 5 is a left end elevation of the accessory of FIGS. 1-4.

FIG. 6 is a transverse longitudinal sectional view of the accessory of FIGS. 1-5, taken on the line 6-6 of FIG. 3.

FIG. 7 is an oblique broken elevation of the right end of the accessory, taken on the line 7-7 of FIG. 6.

FIG. 8 is top plan view of a second embodiment including a different configuration of a support hook.

FIG. 9 is a side elevational view of the embodiment shown in FIG. 8.

FIG. 10 is a spoon part end elevational view of the embodiment shown in FIG. 8.

FIG. 11 is an end view from the tubular storage part end of the embodiment shown in FIG. 8.

FIG. 12 is a perspective view of the spoon part and mounting hook of the embodiment shown in FIG. 8.

FIG. 13 is a top plan view of a third embodiment showing textured thumb and finger indentations for the feeder.

FIG. 14 is a side elevational view of the embodiment shown in FIG. 13.

FIG. 15 is an enlarged, schematic cross sectional view of a fourth embodiment showing a convex curved outer surface of the central depression.

FIG. 16 is an enlarged cross sectional view of a fifth embodiment showing a straight, angled outer surface of the central depression.

FIG. 17 is an enlarged cross sectional view of a sixth embodiment showing a straight, perpendicular outer surface of the central depression.

FIG. 18 is a schematic drawing showing a curvature for the central depression that corresponds to a segment of a circle.

FIG. 19 is an exaggerated schematic drawing showing a curvature for the central depression that corresponds to a segment of an oval.

FIG. 20 is an exaggerated schematic drawing showing a curvature for the central depression that is oblong.

FIG. 21 shows a first embodiment of a kit including the feeding device similar to that of FIG. 1 and instructions.

FIG. 22 shows a second embodiment of a kit including a cleaning brush.

FIG. 23 shows a stand configured to be used in conjunction with the embodiments of FIGS. 1-22.

### DETAILED DESCRIPTION

The embodiments disclosed herein include instruments and methods for feeding or medicating the infant, and facilitating transfer of food or medicine toward the infant's lips or tongue.

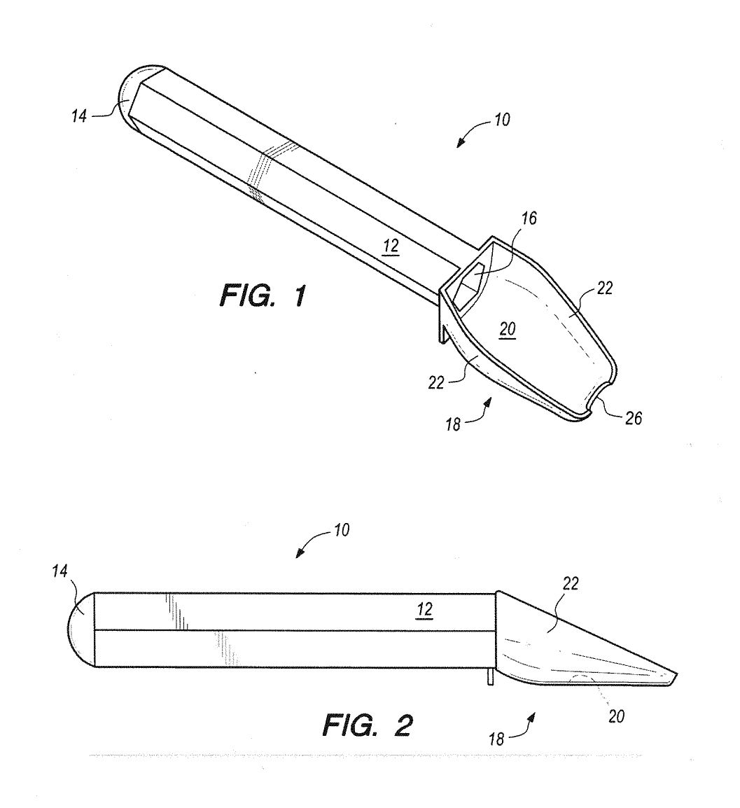

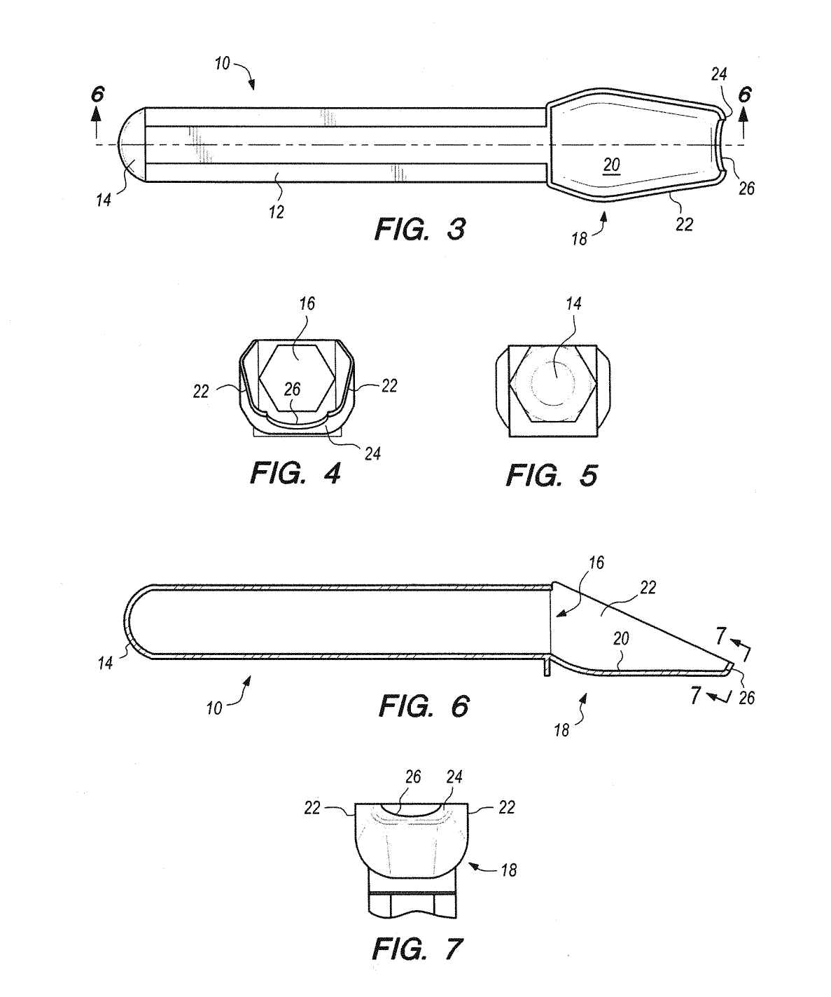

Referring first to FIGS. 1-3, there is shown a feeding accessory 10 for use by neonatal personnel, to facilitate the introduction of measured amounts of food or medicine to an infant being cared for, as by a parent at home or at a hospital, or a nurse, or other care provider.

The accessory 10 comprises an elongate tubular storage part 12 adapted to be held in the hand of a nurse or other attendant, and having at its distal end a closed wall 14. The tubular storage part 12 is usually marked on the exterior surface, to indicate ml. or cc. volumes. These have been omitted from FIGS. 1-3 of the present application, for the purpose of clarity.

The proximal end of the storage part 12 is open, and connects with a spoon part 18 having a generally flat central plateau portion 20. Disposed at the sides of the plateau portion are oppositely located upwardly extending side flanges 22 to confine the food or medicinal substance to the central plateau portion of the spoon part. The spoon part 18 further has a proximal end connected with the open end of the storage part 12, and at its distal end, a transverse upwardly extending flange 26.

In accordance with the present invention there is provided, in combination with the foregoing structure, a novel and improved cradling feature of the spoon, comprising a central depression 26 in the upwardly extending end flange 24, which facilitates optimum positioning of an infant's tongue when the infant is receiving food or medicine. The depression 26 is particularly illustrated in FIG. 7. By the present arrangement, food or medication from the tubular storage part 12 can be transferred, in a slow and controlled manner, across the plateau 20 of the spoon part and into the infant's mouth. Since the provision of the depression 26 can complement the infant's tongue, the likelihood of spillage from the plateau portion dripping onto the infant's chin is minimized, thereby avoiding the mess that characterized sane of the prior art designs for such devices. Also, since little material is lost, the desired dosage of medication or quantity of food can be established or controlled, as determined by the person utilizing the accessory.

In embodiments, the spoon part 18 of the feeding accessory 10 can be configured to have a central depression 26 with a length at the upper end of about 4 mm to about 13 mm, or about 5 mm to about 12 mm, or about 7 mm to about 10 mm. In embodiments, the spoon part 18 of the feeding accessory 10 can be configured to have a central depression 26 with a maximum depth of about 2 mm to about 10 mm, or about 3 mm to about 7 mm, or about 4 mm to about 6 mm. A feeding accessory 10 for an infant who is not premature typically has a spoon part with a central depression having a length at the upper end of 10 mm+/−2 mm and a maximum depth of 5 mm+/−1 mm. A feeding accessory 10 for an infant who is premature typically has a spoon part with a central depression having a length at the upper end of 7 mm+/−2 mm and a maximum depth of 5 mm+/−1 mm.

The shape of the curve of the central depression 26, when viewed from the end of the spoon part 18, typically corresponds to the segment of a circle, but alternatively can be oblong or oval-shaped. In embodiments, when the central depression has an oblong shape or is shaped as a segment of a circle, the radius of curvature of the curved portion is in the range of about 2 mm to about 8 mm, or about 3.5 mm to about 7 mm, or about 4 mm to about 6 mm.

The tubular storage part 12 has a width and diameter such that is can conveniently be held by a user. The length will depend upon the width and diameter, and also upon the desired storage volume. In embodiments, the tubular storage part is configured to hold about 5 ml to about 30 ml of liquid, or about 8 to about 20 ml or liquid, or about 8 to about 12 ml of liquid.

From the above it can be seen that an improved feeding accessory is shown which is simple in its structure, relatively easy to fabricate in quantities, as by simple plastic mold cavities, and easy to use. The provision of the depression 26 at the distal end of the spoon part 18 effectively engages tactile nerves in the tongue of the infant, which in effect serves as a guide for optimal alignment with his tongue and lips. The invention as described above thus constitutes a distinct advance and improvement in the field of neonatal care.

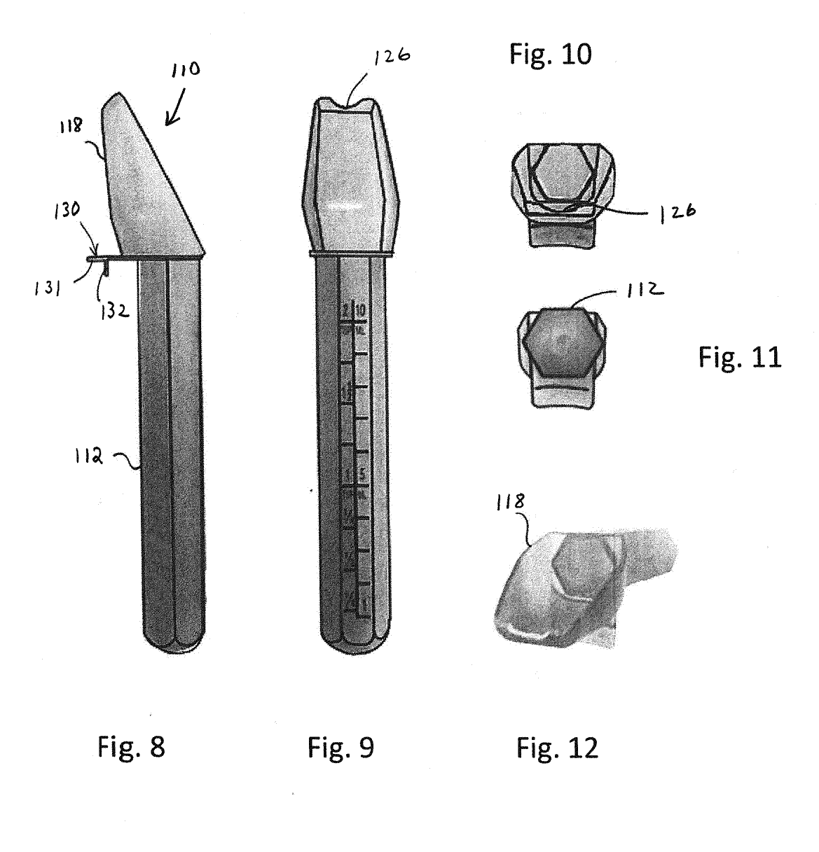

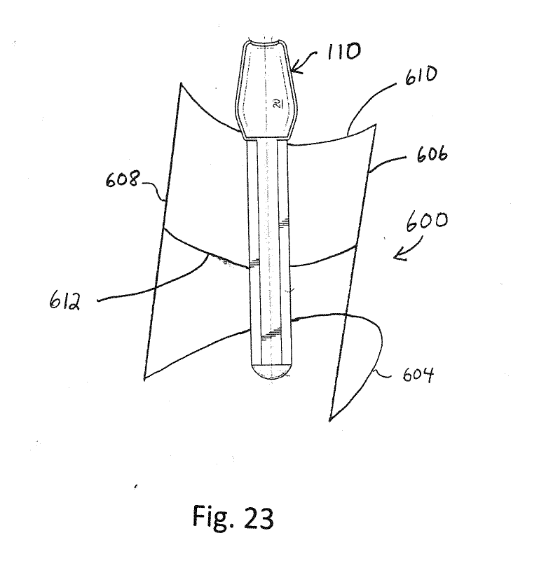

A further embodiment is shown in FIGS. 8-12. FIG. 8 shows a feeding accessory 110 having a mounting hook 130 formed on the tubular storage part 112. The mounting hook 130 includes a spoon rest 131 configured to keep the spoon part 118 and the central depression 126 off of a surface when the feeding accessory 110 rests horizontally on the surface. A hook portion 132 extends generally perpendicularly from the spoon rest 131 to enable the feeding accessory 110 to be temporarily mounted to a vertical support, such as a drinking glass or the support 600 shown in FIG. 23. In some cases, the edge of the spoon rest 131 that contacts a surface when the spoon is resting is contoured to provide enhanced comfort for when the feeding accessory is being held by a user.

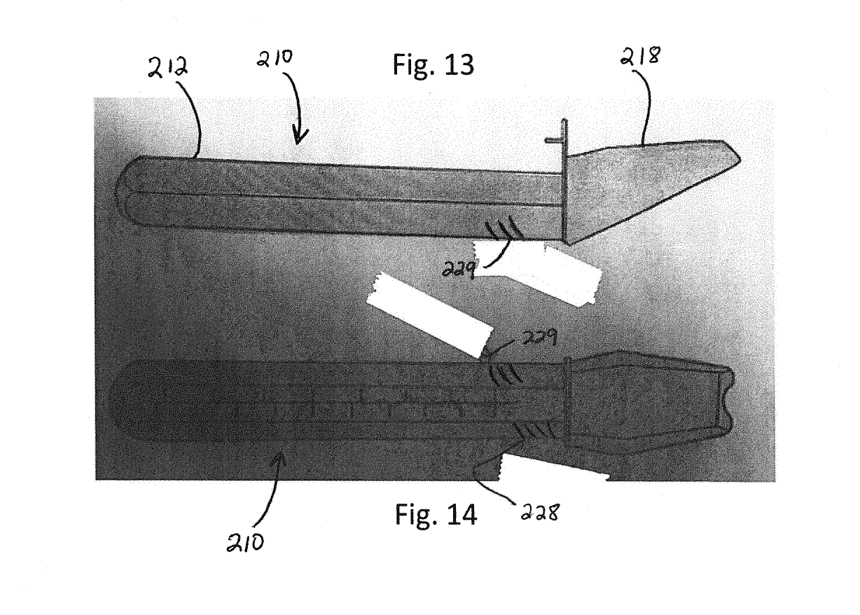

FIGS. 13-14 show a feeding accessory 210 having textured finger protrusions or indentations 228 and textured thumb protrusions or indentations 229 formed on the tubular storage part 212. The protrusions or indentations provide the user with guidance about where to grip the feeding accessory, and, in some cases, reduce the likelihood that the user's fingers will slip while they are gripping the feeding accessory 210.

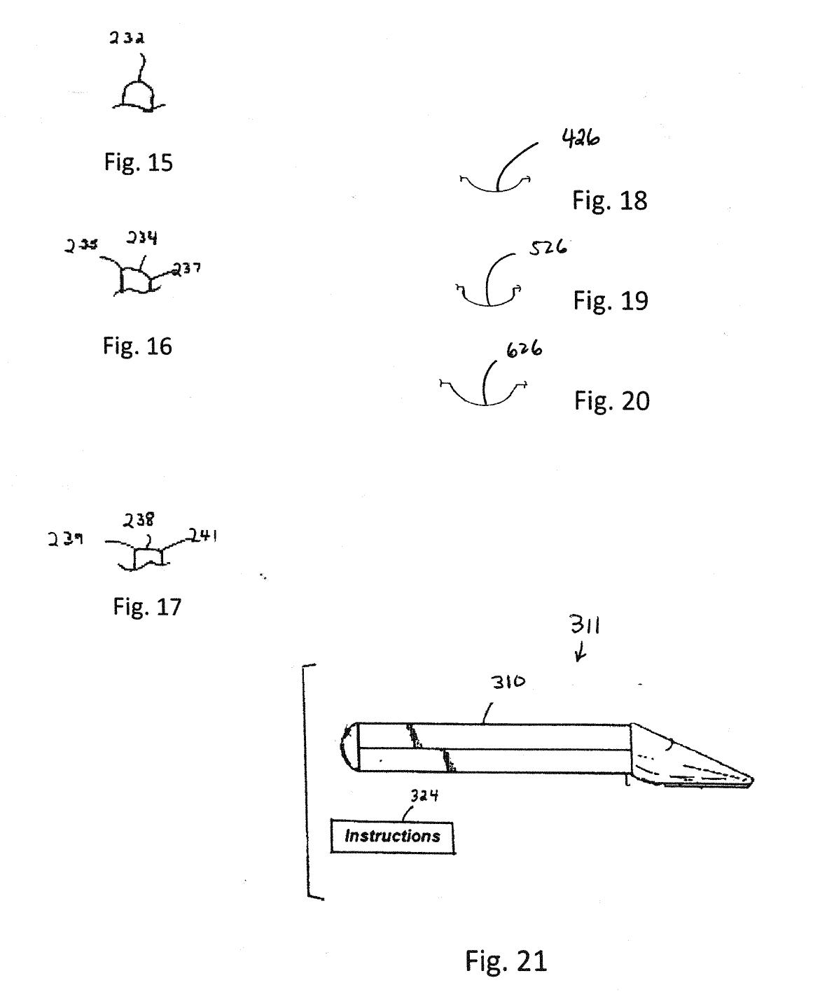

FIGS. 15-17 show various cross sectional shapes for the wall defining the central depression 226, which is the wall that the infant's tongue is in contact with during feeding. FIG. 15 shows a wall 232 with a convex curved shape. FIG. 16 shows a wall 234 with an angled cut and rounded corners 235, 237. FIG. 17 shows a generally perpendicular wall 238 with rounded corners 239, 241.

FIGS. 18-20 show three non-limiting examples of shapes that can be used in forming the central depression. FIG. 18 shows a central depression 426 defined by a wall surface having a configuration corresponding to a segment of a circle. FIG. 19 shows a central depression 526 defined by a wall surface having an oblong configuration. FIG. 20 shows a central depression 626 defined by a wall surface having a configuration corresponding to a segment of an oval.

FIG. 21 shows a kit 311 that includes a feeding accessory 310 and a set of instructions 324 for using the feeding accessory 310. In embodiments, the instructions are printed on paper. In some cases, the instructions are accessible over a computer through internet or the like. In embodiments, the instructions include video and/or audio instructions.

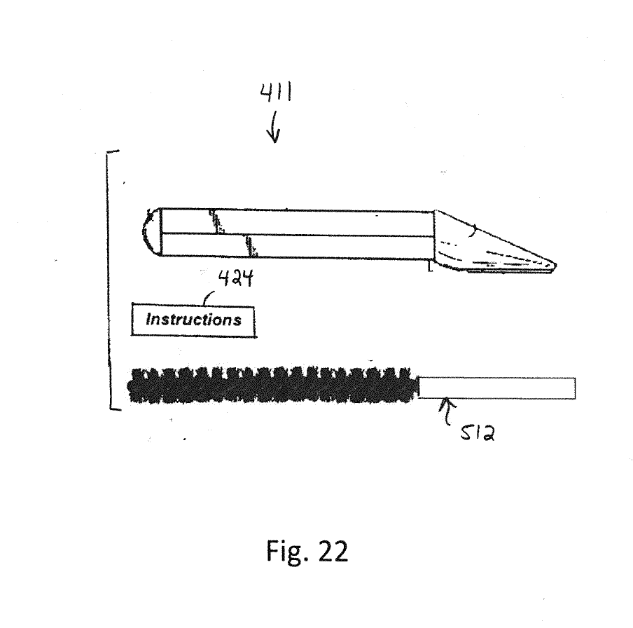

FIG. 22 shows a kit 411 that includes a cleaning brush 512 (for cleaning the tubular storage part) in addition to instructions 424 and the feeding accessory.

FIG. 23 shows a stand 600 that is dimensioned to support the feeding accessory 110. The stand includes a base 604, vertically extending members 606, 608, and a horizontally extending mounting bar 610 configured to vertically support the feeding accessory 110 by the mounting hook 130. Inclusion of an intermediate bar 612 will prevent the feeding accessory from swinging while it is mounted on the bar 610. Use of the stand 600 keeps the feeding accessory clean.

The feeding accessory is often used as a breastfeeding training spoon. It has been found that infants who are having difficulty with breastfeeding can learn the proper tongue action for breastfeeding if they are first fed with the feeding accessory. In seeking food, the infant will move their tongue through the central depression to reach the liquid and then retract their tongue to drink the liquid. The feeding accessory is particularly useful when the liquid is colostrum, as the thickness of the colostrum makes it relative easy for the infant to retain the liquid with their tongue. The dimensions of the central depression and the shape of the distal wall forming the central depression facilitate the training of the infant with their tongue movement. In addition to breast milk, the feeding accessory also can be used with milk-based infant formula, non-milk-based infant formula, medicine, water and the like.

In some cases, the feeding accessory is formed from at least one of a thermoplastic and a thermoset material. In some cases, the feeding accessory is compression molded or injection molded as a one-piece component. In embodiments, the feeding accessory is 3D printed.

In embodiments, the feeding accessory is dimensioned to directly receive expressed breast milk from a mother. In some cases, the feeding accessory is dimensioned to receive liquid from a separate container that contains the liquid. The feeding accessory can be part of a kit that includes video instructions for using the feeding accessory.

The present invention may be embodied in other specific forms without departing from the spirit of any of the essential attributes thereof; therefore, the illustrated embodiment should be considered in all respects as illustrative and not restrictive, reference being made to the appended claim and to the foregoing description, to indicate the scope of the invention.

Variations and modifications are possible without departing from the spirit of the disclosed embodiments.

### LIST OF REFERENCE NUMERALS

10, 110, 210, 310 Feeding accessory
12, 112, 212 Tubular storage part
14, 314 Closed end of the storage part
16 Open end of storage part
18, 118, 218 Spoon part
20, 320 Central plateau of spoon part
22 Upwardly extending side flanges
24 Transverse upwardly extending end flange
26,126,426,526,626 Central depression in end flange
228 Textured finger indentations
229 Textured thumb indentations
130 Mounting hook
131 Spoon rest
132 Hook part
232 Convex curved wall forming central depression
234 Downwardly angled wall forming central depression
235, 237 Rounded corners
238 Straight cut wall forming central depression
239, 241 Rounded corners
311, 411 Kit
324, 424 Instructions
512 Cleaning brush
600 Stand
604 Base
606, 608 Vertically extending members
610 Horizontally extending mounting bar
612 Intermediate bar

The embodiments of the invention in which an exclusive property or privilege is claimed are defined as follows:

1. A feeding accessory for administering food or medication to neonatal infants, comprising in combination:
a) an elongate tubular storage part having an open end and a closed end, for temporarily holding measured quantities of food or medication to be administered orally to an infant, as by a parent at home, or a nurse or other care provider,
b) a spoon part having a proximal end that is connected to the storage part at its open end, and having a distal end adapted to engage the infant's lips and tongue,
c) said spoon part having two oppositely disposed upwardly extending side flanges, to channel the flow of the food or medication toward the distal end of the spoon part,
d) said spoon part further having at its distal end, a transverse upwardly extending flange transverse to its side flanges,
e) said distal end of the spoon part further comprising a central depression, constituting a cradling seat for the infant's tongue while the food or medication is exiting the spoon part and entering the mouth of the infant.

2. The feeding accessory of claim 1, wherein the central depression has a length of about 4 mm to about 13 mm and a maximum depth of about 2 mm to about 10 mm.

3. The feeding accessory of claim 1, wherein the elongate tubular storage part has an outer surface configured to be held by a user, and the outer surface includes textured finger indentations indicating where the feeding accessory is to be held.

4. The feeding accessory of claim 1, wherein the storage part has an outer surface, and a mounting hook is formed on the outer surface to enable the feeding accessory to be mounted to a support.

5. The feeding accessory of claim 4, wherein the mounting hook includes a spoon rest.

6. The feeding accessory of claim 5, wherein the mounting hook includes a hook portion extending outwardly from the spoon rest.

7. The feeding accessory of claim 1, wherein the central depression is defined by a wall having a convex curvature.

8. The feeding accessory of claim 1, wherein the central depression is defined by a wall having a straight configuration.

9. The feeding accessory of claim 1, wherein the central depression is defined by a beveled wall with a flat cross-section.

10. The feeding accessory of claim 1, wherein the feeding accessory is dimensioned to directly receive expressed breast milk from a mother.

11. The feeding accessory of claim 1, wherein the feeding accessory is form from at least one of a thermoplastic and a thermoset material.

12. A kit comprising the feeding accessory of claim 1 and instructions for using the feeding accessory.

13. A method of feeding an infant, comprising:
obtaining a portable feeding accessory comprising an elongate tubular storage part having an open end and a closed end, for temporarily holding a liquid to be administered orally to an infant, and a spoon part connected to the storage part and having a distal portion comprising a central depression configured to receive an infant's tongue during a feeding,
depositing the liquid into the storage part,
pivoting the feeding accessory in order that a portion of the liquid moves from the storage part to the spoon part, and
placing the distal portion of the spoon part in contact with the lips of an infant, thereby enabling the infant to move their tongue onto the spoon part through the central depression in order to drink at least a portion of the liquid located in the spoon portion using their tongue.

14. The method of claim 13, further comprising:
after enabling the infant to drink at least a portion of the liquid located in the spoon using their tongue, further pivoting the spoon part to cause additional liquid to move from the storage part to the spoon part of the feeding accessory.

15. The method of claim 13, wherein the liquid comprises breast milk.

16. The method of claim 13, wherein the liquid comprises colostrum.

17. The method of claim 13, when the step of depositing comprises expressing breast milk directly into the feeding accessory.

18. The method of claim 13, wherein the step of depositing comprises transferring previously expressed breast milk from a first container to the storage part.

19. A method of teaching an infant a tongue movement comprising feeding a liquid to the infant using the feeding accessory of claim 1.

20. The method of claim 19, wherein the tongue movement is an action that trains an infant for future breastfeeding.
